(19) United States
(12) Patent Application Publication
(10) Pub. No.: US 2023/0275886 A1
(43) Pub. Date: Aug. 31, 2023

(54) CRITICAL EVENT TRIGGERS FOR CONTINUOUS ACCESS EVALUATIONS DURING COMMUNICATION SESSIONS

(71) Applicant: MICROSOFT TECHNOLOGY LICENSING, LLC, Redmond, WA (US)

(72) Inventors: Vikas Malik, Bothell, WA (US); Rappaport Nir Mardiks, Bellevue, WA (US)

(21) Appl. No.: 17/681,154

(22) Filed: Feb. 25, 2022

(51) Int. Cl. H04L 9/40

(52) U.S. Cl. CPC H04L 63/0807; H04L 63/083; H04L 63/108; H04L 63/102

(57) ABSTRACT

The disclosure is directed towards providing resource providers, identity service providers (IDPs), and proxy services the ability to continuously evaluate one or more (temporally varying) conditions for which a user's permissions to access resources of the resource provider is dependent upon. The disclosure provides various mechanisms for continuous access evaluation (CAE), such that the finite lifetime of an access token (AT) does not temporally quantize the ability to limit (or otherwise update) a client's access to the resource provider when conditions change that would otherwise change the client's permissions.

### BACKGROUND

Access tokens (ATs) provide a mechanism for a computer device (or a user of a computing device) to inform one or more other computing devices that they have been authenticated and granted access to one or more resources stored at the one or more other devices. For example, a user of a computing device may submit a request to a web and/or cloud service provider. The request may be a request to access one or more resources of the web and/or cloud service provider. The computing device and/or the user of the computing device may be referred to as a client of the resource provider (e.g., the web and/or cloud service provider). The resource provider may employ an identify provider service (IDP) to authenticate the user. The IDP may be operated by the resource provider or another party. In such circumstances, the user is routed to the IDP and prompted to provide their access credentials associated with the resource provider. Upon successful authentication, the IDP may issue an AT to the client-computing device. The AT may encode one or more indications that the client has been authorized to access at least a subset of the provider's resources. In some implementations, the AT may encode indications of various access permissions (e.g., read, write, and execute permissions) associated with the client and the provider's resources. When submitting subsequent requests, the client may provide the AT to the resource provider so that the provider is informed that the client has been successfully authenticated. Thus, in addition to identification/authentication services, the IDP may provide token issuance services.

In conventional implementations, ATs have an associated lifetime, often encoded in one or more timestamps included in the AT. For example, the lifetime of an AT may be one hour from the time of issuance. After one hour, the AT may expire. When the client submits an expired AT to the resource provider, the resource provider may deny access to their resources. Upon a denial of service resulting from an expired AT, the client may request a new (or refreshed) AT. Accordingly, the window of opportunity for the resource provider to reevaluate the client's permission is often quantized (in time) due to the non-zero (but finite) lifetime of the AT. For example, after an AT has been issued, but prior to the AT's expiration time, an administrator may update one or more access policies at the IDP to revoke the client's permission to access the provider's resources. In such conventional scenarios, because the client's permissions have been altered at the IDP layer, the resource provider may not be aware of the revocation (or change) of the client's access permissions. Because the AT has not yet expired, the resource provider may continue to allow the client to access their resources, even though the client's permissions have been revoked. Upon expiration of the AT and when the client requests a refreshed AT, due to the updated permissions at the IDP, the IDP will not issue the refreshed AT. However, until the AT expires, the revoked permissions may not affect the client's ability to access resources of the provider. Accordingly, in conventional implementations, the capability of the resource provider to evaluate client access is temporally quantized based on the lifetime of the AT.

### SUMMARY

Various aspects of the technology described herein are generally directed to systems, methods, and computer storage media, for, among other things, enabling the continuous access evaluation (CAE) for communication sessions. One exemplary, but non-limiting method embodiment, a method may include receiving, at a first computing device and from a second computing device, a request for an access token (AT). The AT may correspond to a third computing device. The method may further include determining that the second computing device is authorized to access the third computing device. Such a determination may be based on at least the second computing device satisfying an access policy. In response to determining that the second computing device is authorized to access the third computing device, the first computing device may provide the requested AT to the second computing device. An event may be detected that renders the second computing device as now not satisfying the access policy. The detected event may be a critical event. In response to detecting the event, the first computing device may provide to the third computing device an indication that the second computing device does not now satisfy the access policy.

In various embodiments, the event may include at least one of a deletion of a user account, a disabling of the user account, a change in a user password, a reset of the user password, an enablement of a multi-factor authentication mechanism, a revocation of the AT, a detection of a risk associated with the second computing device, a detection of a risk associated with the third computing device, or a change of an internet-protocol (IP) address associated with the second computing device.

In any combination of the above embodiments, the first computing device may be associated with an identity provider (IDP). The second computing device may be a client computing device, and the third computing device may be associated with a resource provider. When the event is detected, the AT may be valid and/or unexpired. The third computing device may subscribe to a notification service of the first computing device. Providing the indication that the second computing device does not now satisfy the access policy may be based on the third computing device subscribing to the notification service of the first computing device.

In any combination of the above embodiments, a permission for the second computing device to access the third computing device when the second computing device does satisfy the access policy may be different from a permission for the second computing device to access the third computing device when the second computing device does not satisfy the access policy. The event may include a change to the access policy.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 illustrates a block diagram showing an example operating environment in which some embodiments of the present disclosure may be employed;

FIG. 2A illustrates a block diagram showing a continuous access evaluation-enabled communication session that is consistent with the various embodiments;

FIG. 2B illustrates a block diagram showing another continuous access evaluation-enabled communication session that is consistent with the various embodiments;

FIG. 2C illustrates a block diagram showing another continuous access evaluation-enabled communication session that is consistent with the various embodiments;

FIG. 3A illustrates a flow diagram of a method for enabling a continuous access evaluation communication session between a client and a resource provider;

FIG. 3B illustrates a flow diagram of another method for enabling a continuous access evaluation communication session between a client and a resource provider;

FIG. 4 shows a flow diagram is provided that illustrates another method for enabling a continuous access evaluation communication session that includes a proxy service; and

FIG. 5 is a block diagram of an exemplary computing environment suitable for use in implementing aspects of the technology described herein.

### DETAILED DESCRIPTION

### Overview of Technical Problems, Technical Solutions, and Technological Improvements

The embodiments herein are directed towards providing resource providers, identity service providers (IDPs), and proxy services the ability to continuously evaluate one or more (temporally varying) conditions for which a user's permissions to access resources of the resource provider is dependent upon. That is, the embodiments provide various mechanisms for continuous access evaluation (CAE), such that the finite lifetime of an access token (AT) does not temporally quantize the ability to limit (or otherwise update) a client's access to the resource provider when conditions change that would otherwise change the client's permissions.

As mentioned above, conventional implementations of ATs update a client's permissions only after the expiration of the client's AT, even though the conditions for which the client has been granted permissions may change prior to the AT's expiration. Rather than being based on a fixed temporal window characterized by AT's lifetime, the various embodiments provide a mechanism to continuously monitor environmental conditions and detect when conditions change such that the client's permission to access the provider's resource should also change. A change in environmental conditions that should cause a change in client's access permissions may be referred to as a “critical event.” When a critical event is detected (e.g., via one or more critical event triggers), the various embodiments may provide one or more signals to the resource provider that the client's permissions should be updated based on the changing conditions. Rather than waiting for the client's AT to expire, the resource provider may update the client's permission in accordance with receiving the indication of the detection of the critical event. The indication may encode the consequences of the critical event (e.g., the client's permissions should be revoked, restricted, broadened, or the like) so that the resource provider may update the user's ability to access their resources accordingly. Thus, the resource provider may evaluate, in real-time (or near real-time), the client's current ability to access the resources and limit or allow access to the resources accordingly.

As noted above, the term “client” may refer to a computing device accessing a resource provider, or it may refer to a user of the “client” computing device. Examples of critical events include but are not limited to: a user account (e.g., a user of the client computing device) being disabled or deleted, a password for the user being changed or reset, or a multi-factor authentication mechanism being enabled for the user. Additional examples of critical events include but are not limited to: an administrator explicitly revoking the user's access, risky activity associated with the user, or the client computing machine being re-located outside of an allowed geographical (or logical) address, or other such changes to the user's (or the client device's) conditions. Still other non-limiting examples of critical events include updates to one or more policies that dictate a user's access permissions and the like.

In various embodiments, the monitoring and detecting of critical events may be performed by a “backend” of an IDP employed by the resource provider to authenticate and issue ATs to the resource provider's users. In some embodiments, the resource provider may “subscribe” to receive various indications of critical events. In at least some embodiments, the monitoring and detecting of critical events may be performed by a backend of a proxy service that the user is employing to communicate with the resource provider and/or another IDP that the proxy service employs to authenticate and issue tokens to the users. Various access policies, implemented at an IDP, resource provider, and/or a proxy service, may be synchronized at regularly scheduled intervals between the service that is monitoring and detecting critical events and the resource provider. In some embodiments, the access policies may be synchronized across the various platforms when a change in a policy is detected and/or when other critical events are detected (or triggered).

Accordingly, the various embodiments reduce refresh time (for evaluating access permissions) by using a critical event trigger, rather than waiting the AT to expire. In some embodiments, a proxy service (e.g., a man-in-the-middle) evaluates its own policies, which may be different from the access policies of the resource provider. The backend service of the resource provider may sync the policies (e.g., with the IDP and/or the proxy service). The backend service for the IDP and/or the proxy service may monitor and detect critical events. In some embodiments, the IDP may monitor and detect critical events (e.g., password reset, account deleted/disabled, high-risk user etc.). The backend service of the proxy service may subscribe to a backend service of the IDP. Based on the subscription, the IDP may notify the backend of the proxy service when a critical event is detected at the IDP. The notification may also inform the proxy service as to the consequences (with respect toe the client's access permissions) of the detected critical event. Based on this notification, when the next time the client attempts to communicate with the IDP (though the proxy service), the proxy service can reject the client's attempt and challenge the client to re-login to the service provider to receive a new AT. In such embodiments, the proxy service manages the continuous access evaluation, without a need to directly update and/or inform the resource provider of the change in the client's access permissions. Rather, if the client is issued a new AT, the resource provider will be informed of the changed access permissions when the new AT is presented to the resource provider.

In other embodiments, the backend of the resource provider may subscribe to be notified (in real-time) for the detection of critical events (e.g., password reset, account deleted/disabled, high-risk user etc.) from the IDP and/or the proxy service. Whether the proxy service or the resource provider receives such notifications, based on the additional information now synced by the backend service from the IDP and/or proxy service, the backend service of the resource provider becomes capable of rejecting ATs because the IDP is no longer satisfied, or due to a critical event received for a user. Generally, whether the proxy service or the resource provider receives the notification of the detected critical event, the detection of a critical event may obviate the need to wait for the expiration of the AT in order to update the client's access permissions. As noted above, the backend of the proxy service (or the resource provider) subscribe to be notified of the detection of critical events at the IDP (or the proxy service). As such, the backend service of the proxy service (or the resource provider) may receive an indication from the IDP (or the proxy service) that an AT is no longer valid. Thus, the backend of the proxy service (or the resource provider) may force a refresh of the AT from the IDP prior to the finite lifetime of the AT expiring.

### Overview of Environments for Providing Continuous Access Evaluation

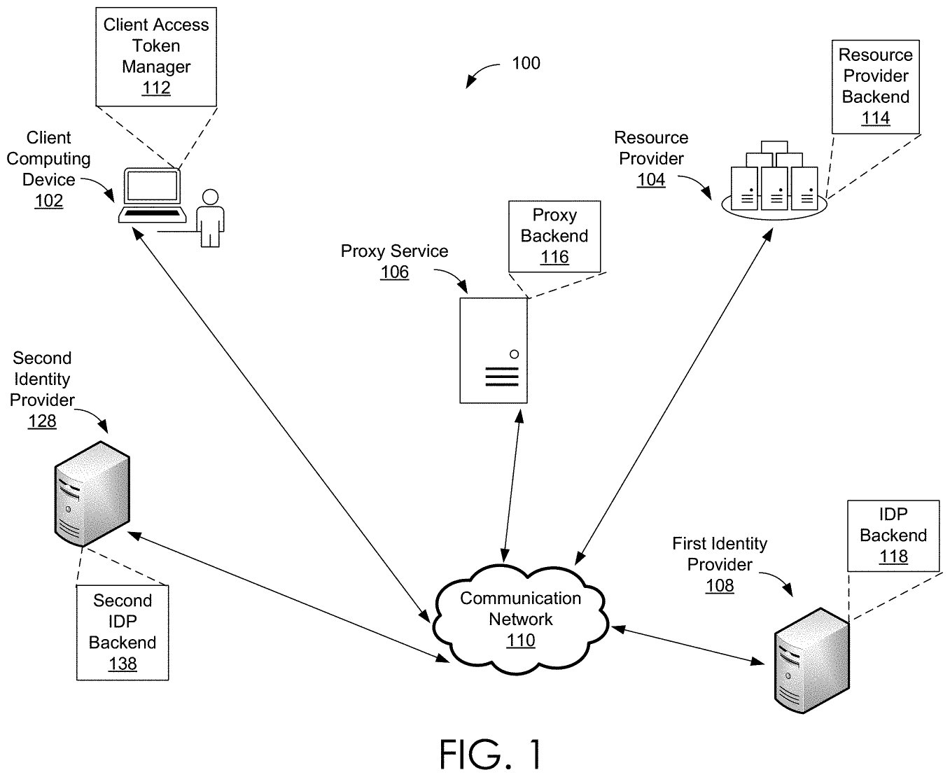

AT expiration and refresh is a conventional mechanism implemented in communication sessions carried out over a communication network (e.g., communication network 110 of FIG. 1). When a client attempts to request a resource from a resource provider, the client may issue an application programming interface (API) function call to a backend of the resource provider. The resource provider may authorize requests (such as but not limited to API-based requests) via ATs. A conventional AT may be valid for a finite lifetime that is long when compared to the timescale for reevaluating the client's access permissions. For example, an AT may be valid for one hour after the time of issuance. After one hour, the AT may expire. After the AT has expired, the client may be redirected to the IDP to refresh the AT. In conventional implementations, an opportunity to re-evaluate the access policies for the client may only occur after the expiration of the AT. After the refresh period, the IDP may choose not to refresh the AT because of an access policy change, password change, the client's account having been disabled, or another such critical event. The various embodiments herein enable continuous access evaluation, in contrast to such conventional implementations.

Continuous access evaluation is a mechanism by way of which a backend service of a resource provider be informed, in real-time (or near real-time), of changes in the client's access permissions. A backend service of an IDP or proxy service may monitor and detect critical events that affect a client's access permissions. The backend service of the resource provider may synchronize the updated access policies of the IDP and/or proxy service. Various embodiments may be directed to offloading the synchronizing of updates to access permissions from the resource provider to the proxy service. That is, the IDP may detect a critical event. The proxy service may subscribe to receive notifications of the detected critical events from the IDP. Based on receiving information of the detected critical events, the proxy service is capable of rejecting an AT without having to wait for the AT to expire. Accordingly, to implement the various embodiments, the no changes may be required at the level of the resource provider. In other embodiments, the backend of the resource provider may subscribe to receive notifications of the detection of critical events (such as password reset, account deleted/disabled, high-risk user, and the like.) from the backend of the IDP and/or proxy service. Based on the additional information now synced by the backend from the IDP, the backend of the proxy serviced (or the resource provider) becomes capable of rejecting a non-expired AT, in response to the policy not being satisfied anymore or due to a critical event detected for the client.

Aspects of the technical solution to provide continuous access evaluation (CAE) can be described by way of examples and with reference to FIG. 1 and additional illustrations below. FIG. 1 illustrates a block diagram showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, and/or software. For instance, some functions may be carried out by a processor executing instructions stored in memory.

Among other components (e.g., components not shown in FIG. 1), example operating environment 100 includes client computing device 102 (and a user of client device 102) and a resource provider 104. The environment may additionally include a first identify provider service (IDP) 108 that the resource provider 104 may employ to authenticate and issue access tokens (ATs) to users and client devices, such as, but not limited to, client computing device 102 and its user. Various embodiments of environment 100 may additionally include a proxy service 106 and a second IDP 128, which the proxy service 106 may employ to authenticate and issue ATs to users and/or client computing devices. As shown in FIG. 1, these components may communicate with each other via network 110, which may include, without limitation, a local area network (LAN) and/or a wide area networks (WAN). In exemplary implementations, network 110 comprises the Internet and/or a cellular network, amongst any of a variety of possible public and/or private networks.

Communication network 110 may be a general or specific communication network and may directly and/or indirectly communicatively couple the client computing devices. Communication network 110 may be any communication network, including virtually any wired and/or wireless communication technologies, wired and/or wireless communication protocols, and the like. Communication network 110 may be virtually any communication network that communicatively couples a plurality of computing devices and storage devices in such a way as to enable computing devices to exchange information via communication network 110.

Client computing device 102 may include a client AT manager 112. AT manager 112 may be generally responsible for requesting new ATs, requesting refreshed ATs, receiving the requested ATs, storing the received ATs, and providing the ATs to other parties (e.g., resource provider 104). IDP 108 may include an IDP backend 118 that monitors and detects critical events. A critical event may be any change in environment 100 that has consequences that change (or should change) the client's 102 permissions with respect to accessing resources of the resource provider 104.

As noted above, examples of critical events include, but are not limited to, a user account (e.g., a user of the client computing device) being disabled or deleted, a password for the user being changed or reset, or a multi-factor authentication mechanism being enabled for the user. Additional examples of critical events include but are not limited to an administrator explicitly revoking the user's access, risky activity associated with the user, or the client computing machine being relocated outside of an allowed geographical (or logical) address, or other such changes to the user's (or the client device's) conditions. Still other non-limiting examples of critical events include updates to one or more policies that dictate a user's access permissions and the like.

More specifically, one or more access policies may be implemented by the first IDP 108. An access policy may indicate which clients and/or user are to be granted access to the resource provider 104, as well as under which environmental conditions the client is to be granted access to the resource provider 104 and the nature of the client's permissions (e.g., read, write, and/or execute permissions). For instance, at a first moment in time, an access policy may indicate that a user of a client computing device 102 may be granted access to the resource provider 104. The user may request a resource from resource provider 104. Resource provider 104 may redirect the client computing device to the first IDP 108. The user may provide the first IDP 108 their login credentials. The first IDP provider 108 may verify the user's credentials and check the user's permission status under the current access policies. Based upon one or more conditions of the environment 100 and/or the user's credentials, the first IDP 108 may determine that the user's credentials satisfy a particular access policy (for the resource provider 104) implemented by the first IDP 108. Passing the particular access policy may result in the first IDP 108 determining that the user should be granted access to the resource provider 104. The first IDP 108 may issue a valid AT to the client computing device 102. For future requests (occurring within the lifetime of the AT), and to inform the resource provider that they have been authenticated and granted access to the provider's 104 resources, the client computing device 102 may provide the AT to the resource provider 104.

At a second moment in time that is subsequent to the first moment in time, but prior to the AT expiring, a critical event may occur. The triggering of the critical event may be such that if the particular access policy is evaluated after the second moment in time, the user's credentials would no longer satisfy the particular access policy. Accordingly, after the occurrence of the critical event, the user should no longer be granted access to the resource provider 104. Such critical events may include an administrator of a tenant of the first IDP 108 (or the second IDP 128) updating the particular policy to revoke the user's permissions or the client device 102 switching to an IP address that is outside of a geographical (or logical) range of allowable IP addresses. In at least one non-limiting embodiment, a critical event may include an administrator of the resource provider 104 updating the particular policy to revoke the user's permissions.

As noted above, in conventional implementations, the resource provider 104 may not become aware of the user's revoked permissions until the lifetime of the AT has expired. However, in the various embodiments, the first ADP 108 may implement an IDP backend 118 that monitors and detects such critical events. The resource provider 104 may also implement a resource provider (RP) backend 114. Upon detecting a critical event that causes the user's credentials to fail the access policies, the IDP backend 118 may provide an indication of the critical event to proxy backend 116. The proxy backend 116 may reject ATs whose corresponding client device access permissions are effected. In at least one embodiment, the RP backend 114 may be receive notifications of the detection of critical events. The indication of the critical event (received by the proxy backend 116 or the RP backend 114) may further encode the updated status of the user's permissions. For example, the critical event may cause a revocation of the user's permissions, a narrowing (or limiting) of the user's access permissions, or a broadening of the user's access permissions. Upon receiving an indication of the critical event (and the resulting effect on the user's permissions), the RP backend 114 may inform the resource provider 104 to act in accordance with the updated permissions when the client computing device 102 presents the AT for access. In this way, the resource provider 104 does not have to wait until the current AT expires to be informed of the change in the user's access permissions.

In various embodiments, the IDP backend 118 may provide a subscription service. Clients of the subscription service may be enabled to receive notifications affecting the access permissions of their users. For instance, the resource provider backend 114 may be a client of the event monitoring/reporting subscription service implemented by IDP backend 118. Some embodiments may include a proxy service 106 that implements a proxy backend 116. For example, when communicating with the resource provider 104, the client machine 102 may require security services provided by the proxy service 106. The proxy service 106 may employ a second IDP 128 to authenticate a user of the client device 102. The second IDP 128 may implement a second IDP backend 138. In a similar manner to the monitoring and detecting of critical events offered by the first IDP 108, second IDP backend 138 may monitor and detect critical events that may change a user's access permissions to the proxy service 106 and/or the resource provider 104. The second IDP 128 may provide subscription services to the proxy backend 116 and/or the resource provider backend 114. Accordingly, the proxy service 106 and/or resource provider 104 may be granted continuous access evaluation (CAE) for the client computing device 102 and/or a user of the client computing device 102.

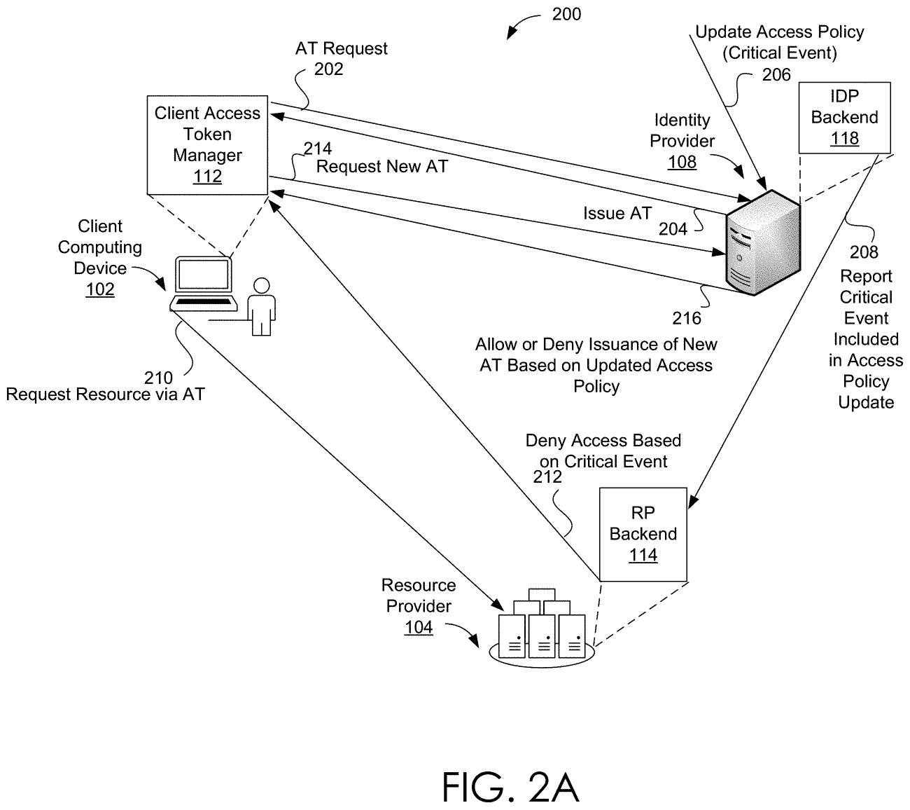

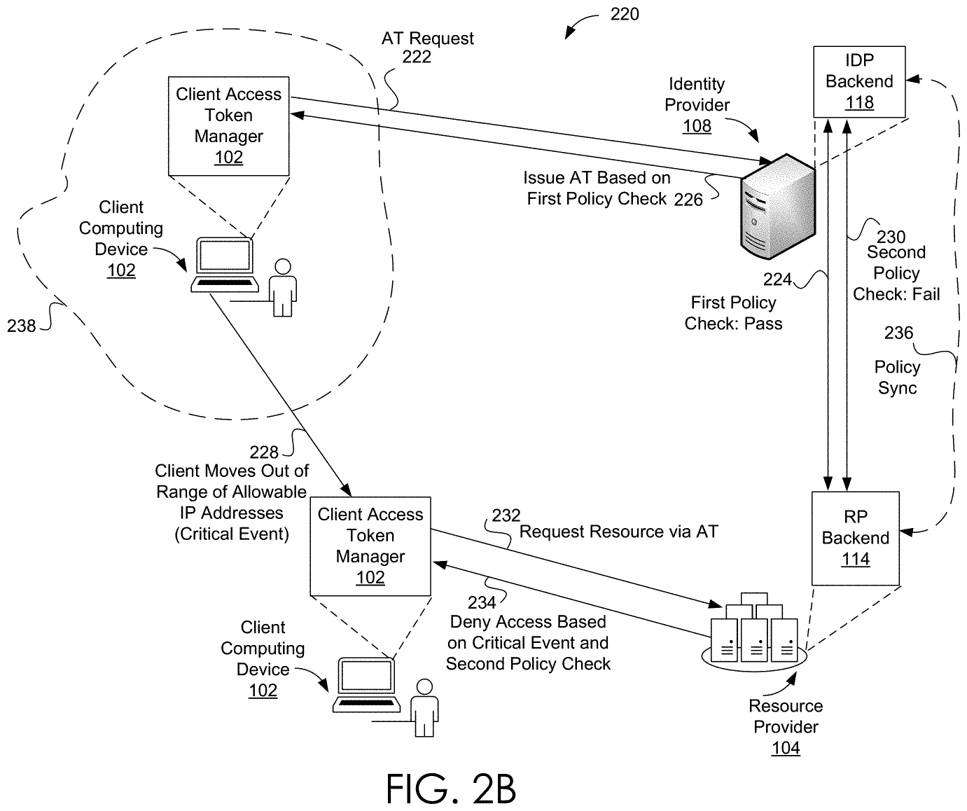

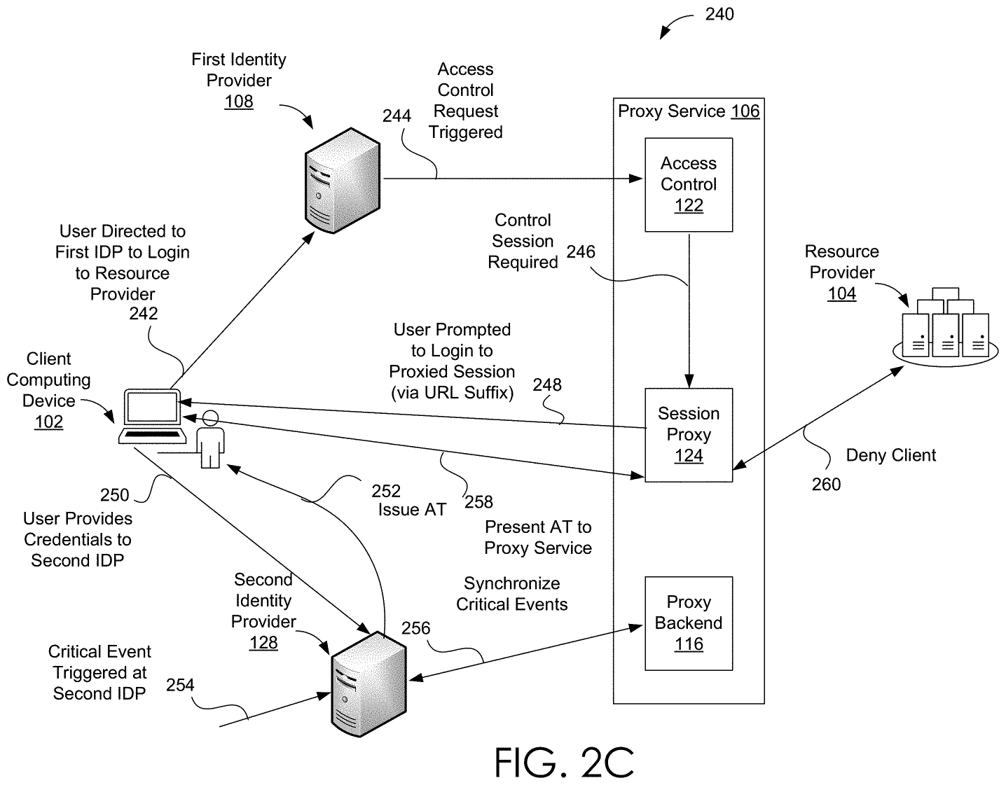

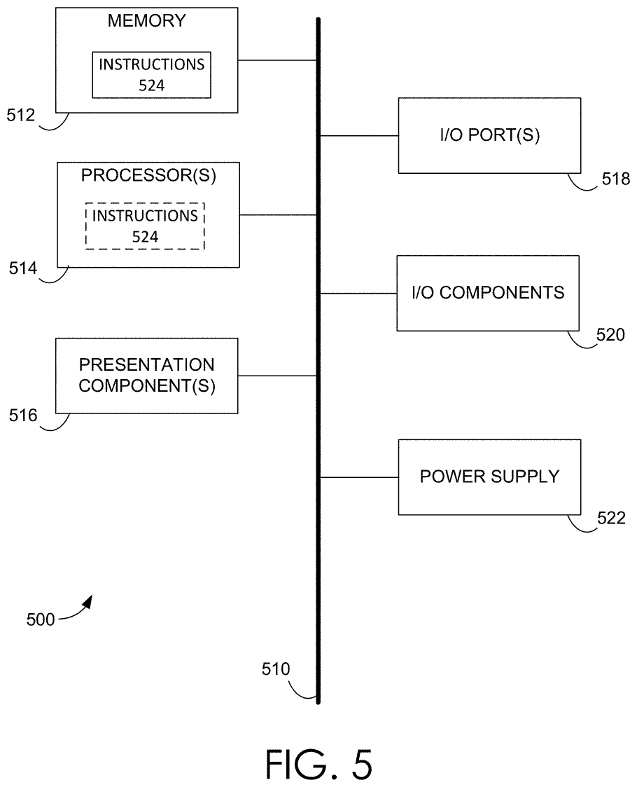

It should be understood that environment 100 shown in FIG. 1 is an example of one suitable operating environment. Each of the components shown in FIG. 1 may be implemented via any type of computing device, such as computing device 500 described in connection to FIG. 5, for example. These components may communicate with each other via network 110, which may include, without limitation, a local area network (LAN) and/or a wide area network (WAN). In exemplary implementations, communications network 110 comprises the Internet and/or a cellular network, amongst any of a variety of possible public and/or private networks. Operating environment 100 can be utilized to implement any of the various embodiments described herein. For instance, operating environment 100 can also be utilized for implementing various aspects described in conjunction with FIGS. 2A-4.

### Overview of Continuous Access Evaluation-Enabled Communication Sessions

FIG. 2A illustrates a block diagram showing a continuous access evaluation-enabled communication session 200 that is consistent with the various embodiments. Continuous access evaluation (CAE) session 200 is enabled by at least some of the components and/or parties discussed in conjunction with FIG. 1. CAE communication session 200 is a communication session between client computing device 102 (and/or a particular user of client device 102) and resource provider 104. As discussed in conjunction with FIG. 1A, resource provider 104 may employ an identity provider service (IDP) (e.g., first ISP 108 of FIG. 1) to authenticate user/client devices, as well as issue access tokens (ATs) upon a successful login. IDP 108 may also serve requests for new and/or refreshed ATs. That is, IDP 108 may issue refreshed ATs and/or refreshed ATs when a client's (e.g., client device 102) AT has expired. As also discussed in conjunction with FIG. 1, client device 102 may implement a client AT manager 112 that manages ATs for the client device 102 and/or the particular user of client device 102. IDP 108 may implement an IDP backend 118 that monitors and detects critical events relating to the access permissions of client device 102 and/or the particular user of client device 102. Resource provider 104 may implement a resource provider (RP) backend 114.

As discussed in conjunction with FIG. 1, when a critical event is detected, IDP backend 118 may notify RP backend of the critical event and/or the consequences to the access permissions of client device 102 and/or the particular user of client device 102. Upon notification, resource provider 104 may adjust their access permission-level for the client computing device when presented with a valid AT by the client device 102. Accordingly, resource provider 104 may be informed in real-time regarding changes to the client device's 102 access permissions and implement those changes in real-time. That is, upon notification of a critical event that changes the client's permissions, resource provider 104 may revoke, limit, or broaden the access of client device 102 to the provider's 104 resources without waiting for the issuance of a new and/or refreshed AT. Thus, via IDP's 108 ability to monitor, detect, and notify interested parties in critical events, the resource provider 108 is provided with CAE. In various embodiments, RP backend 114 may provide a subscription service that offers notification services to interested parties (e.g., resource provider 108). Accordingly, RP backend 114 may subscribe to tee subscription service and be updated, in real-time, of the change in their client's access permissions.

CAE communication session 200 may begin at step 202, where the client AT manager 112 requests a new and/or refreshed AT from IDP 108. The request may originate from a login attempt with resource provider 104 and/or the expiration of a previously issued AT corresponding to the resource provider 104. At step 204, IDP 108 may authenticate the client's 102 credentials and verify the client's 102 access permission level by evaluating one or more access policies corresponding to the client 102. At step 204, the IDP 108 may issue a valid AT in accordance with the client's current permission level, as dictated by the access policies implemented at IDP 108.

At block 206, a change in the environment may occur that changes the client's access permissions. In a non-limiting example, at step 206, an access policy implemented at IDP 108 and corresponding to the client device 102 and/or the resource provider 114 may be changed. For instance, an administrator of resource provider 104 and/or IDP 108 may revoke the account of the particular user of client device 102. This revocation of the user's account may occur subsequent to the issuance of the AT at step 204, but before the AT has expired due to its finite lifetime. The revocation of the user's account at step 206 may cause a critical event trigger at IDP backend 118. As noted throughout, IDP backend 118 may be enabled to monitor and detect such critical events. In real-time (or near real-time), IDP backend 118 may detect a critical event corresponding to the revocation of the particular user's account. At step 206, IDP backend 118 detects the occurrence of the critical event affecting the access permissions of the particular user. Detecting the critical event may include evaluating the access policies that correspond to the particular user, the client device 102, and/or the resource provider 104.

At step 208, the IDP backend 118 may provide an indication of the detection of the critical event to the RP backend 114. The indication may include a report of the critical event, as well as the consequences of the critical event with respect to the user's permissions to resource provider 104. In one embodiment, the indication may include a signal that the particular user now fails to satisfy one or more access policies that they previously satisfied due to the update in the access policy.

At step 210, the client device 102 may request access to a resource of resource provider 104. The request may be accompanied with the presentation of the client's 102 AT to the resource provider 103. In various embodiments, step 210 may occur after step 208, but prior to the AT's expiration time. Accordingly, the AT may still be a valid AT, even though the particular user's account has been revoked at the resource provider 104. At step 212, the RP backend 114 may deny access to the client device 102/user based on the critical event being reported at step 208. At step 212, the resource provider 104 may provide an indication of the denial of access to the client AT manager 112 of client device 102.

In view of the indication of the denial of access provided at step 212, at step 214 the client device 102 may request a new and/or refreshed token from IDP 108. At step 216, the IDP 108 may allow or deny the issuance of the requested new/refreshed AT based on the updated access policies at IDP 108. In the embodiment where the user's account has been revoked, the IDP may deny the issuance of a new AT at step 216. In other embodiments, the IDP 216 may allow the issuance of a new/refreshed AT. Based on the updated access policies, the newly issued AT may reflect updates on the user's access permissions. For example, in an embodiment where the critical event of step 206 includes an administrator narrowing the user's access permissions, the newly issued AT of step 216 may indicate the more narrow access permissions for the user.

FIG. 2B illustrates a block diagram showing another continuous access evaluation-enabled communication session 220 that is consistent with the various embodiments. Similar to continuous access evaluation (CAE) session 200 of FIG. 2A, CAE communication session 220 is enabled by at least some of the components and/or parties discussed in conjunction with FIG. 1. Similar to CAE session 200, CAE communication session 220 is a communication session between client computing device 102 (and/or a particular user of client device 102) and resource provider 104.

CAE communication session 220 starts at step 222. Similar to step 202 of CAE communication session 200, at step 222 of CAE communication sessions 220, the client device 102 may request a new and/or refreshed AT from IDP 108. When requesting an AT at step 222, the user of client device 102 may provide their login credentials corresponding to resource provider 108. At step 224, there may be a first synchronization of access policies between the IDP backend 118 of IDP 108 and the RP backend 114 of resource provider 104. Although not explicitly discussed in conjunction with FIG. 2A, each of resource provider 104 and IDP 108 may implement their own access policies for the client device 102 and/or the particular user of the client device 102. In some embodiments, the IDP 104 may implement all of the access policies for the client device 102 and the resource provider 104. In other embodiments, the resource provider 104 may implement all of the access policies for the client device 102 and the resource provider 104. In still other embodiments, the IDP 108 may implement some of the access policies for the resource provider 104 and the client device 102, while the resource provider 104 implements other access policies for the resource provider 104 and the client device 102. In various embodiments, the two platforms may become aware of the current status of the access policies via a first synchronization of the policies across the resource provider 104 and the IDP 108 via step 224. The synchronization step may include checking whether the client device 102 satisfies one or more of the synchronized policies. For example, at step 224, the access policies may be checked (e.g., analyzed) and the IDP backend 18 may determine that the client device 102 should be granted access to resource provider 104 because the credentials provided by the client device 102 satisfy one or more of the access policies corresponding to the client device 102 and the resource provider 104.

At step 226, based on an analysis of the synchronized policies that determine that the credentials provided by client device 102 and/or the user of the client device 102 satisfy one or more of the synchronized access policies, the IDP 108 may provide an AT to the client AT manager 102. The region bounded by hashed bubble 238 indicates a geographic (or logical) address space of allowable IP addresses. That is, the allowable address space 238 may correspond to a geographical region where only client devices with IP addresses corresponding to the allowable address space 238 may be granted access to resource provider 104. At step 222, where the client device requests the AT, the client device is located within the allowable address space 238. Accordingly, the IP address of client device 102 may correspond to the allowable address space 238 when the IDP 108 analyzes whether the client device 102 satisfies an access policy. Because the client device's 102 URL corresponds to the allowable address space 238, the IDP 108 may issue the AT to the client device at step 226.

At step 228, the client device may move outside of the range of allowable IP addresses space 238. For example, client device 102 may be a mobile device (e.g., a smartphone). At step 228, the user may physically move to a region outside the allowable region 238. The client device 102 may be re-assigned an IP address that does not correspond to an IP address within the allowable address space 238. At step 230, a second policy check and/or policy synchronization may occur between the IDP 108 and the resource provider 104. Upon a recheck of the policies, the new IP address assigned to client device 102 may now fail the access policies. That is, the IDP backend 118 may detect a triggered critical event at step 230. As such, the IDP 108 may provide a signal and/or indication of the detection of the critical event at step 230. The indication may indicate that the client device 102 is now outside the range of allowable addresses 238, and thus the access of client device 102 to the resource provider should be revoked.

At step 232, the (relocated) client device requests a resource from the resource provider. The client device 102 may provide the valid AT to the resource provider 104 at step 232. However, due to the synchronization/reporting/checking of the access policies at step 230, the resource provider 104 is now aware that the client device 102 is now outside the region of allowable addresses 238. Accordingly, at step 234, the resource provider 104 may deny the client device 102 access to the requested resource based on the IDP backend detection of the critical event of the client device moving outside the allowable address space 238. Accordingly, resource provider 104 is provided continuous access evaluations for the client device 102 and/or the particular user of the client device 102. Step 236 may represent a policy synchronization between the IDP backend 118 and the RP backend 114.

Turning attention to FIG. 2C, FIG. 2C illustrates a block diagram showing another continuous access evaluation-enabled communication session 240 that is consistent with the various embodiments. Similar to continuous access evaluation (CAE) session 200 of FIG. 2A, CAE communication session 240 is enabled by at least some of the components and/or parties discussed in conjunction with FIG. 1. Similar to CAE session 200, CAE communication session 240 is a communication session between client computing device 102 (and/or a particular user of client device 102) and resource provider 104. However, in CAE communication session 240, the client device 102 requires a proxy service (e.g., proxy service 106 from FIG. 1) to communicate with resource provider 104. As shown in FIG. 2C, proxy service 106 sits between the client computing device 102 and the resource provider 104.

As shown in FIG. 2C, the proxy service 106 may include an access control module 122, a session proxy module 124, and a proxy backend 116. Proxy service 106 may be a suffix proxy service. When a client device (e.g., client device 102) attempts to communicate with a resource provider (e.g., resource provider 104), the client device may be redirected to login to a secondary IDP that the proxy service 106 employs (e.g., second IDP 128). That is, when the requesting URL is suffixed, the proxy service 106 may redirect the client 102 to second IDP 128 to login to the proxy service 106. In some embodiments, both the resource provider 104 and the proxy serviced 106 may re-direct the client to the same IDP for authentication. The backend of the second IDP 128, the backend of the first IDP 118, and/or the proxy service backend 116 may synchronize the access policies with the first IDP 108. The backend of the second IDP 128 and/or the backend of first IDP 108 may detect critical events. The proxy backend 116 may subscribe to the critical events detection service of the first IDP 108 and/or second IDP 128. The backend of the second IDP 128, the backend of the first IDP 118, and/or the proxy backend 116 may evaluate when the communication session needs to be terminated and/or the client needs to be challenged to re-login to receive a new and/or refreshed AT. The proxy backend 116 may evaluate the policies and synchronize the policies across the platforms. When the proxy session is terminated, the client's access to the resource provider (e.g., resource provider 104) may also be terminated and/or blocked.

CAE communication session 240 starts at step 222. Similar to step 202 of CAE communication session 200, at step 242 of CAE communication sessions 240 the client device 102 may request a new and/or refreshed AT from first IDP 108. Based on one or more policies implemented at the first IDP 108, at step 244 the client 102 may be redirected to the access control module 22 of the proxy service 106. At step 246, the client 102 may be directed to the session proxy module 124 to provide limited access session services to the client device 102. At step 248, the user may be prompted to logon to the proxied session via the URL suffix. To login to the proxy session, at step 250 the client may be directed to provide their login credentials to the second IDP 128. At step 252, the second IDP 128 may issue an AT to the client device 102.

At step 254, a critical event may be triggered. The second IDP 128 may detect the critical event at step 252. At step 256, the detection of the critical event may be synchronized to the proxy backend 116. At step 258, the client device 102 may present the AT to the session proxy for access to the resource provider 104. Due to the detection of the critical event, at step 260 the proxy session may deny access to the resource provider 104.

### Example Processes for Continuous Access Evaluation

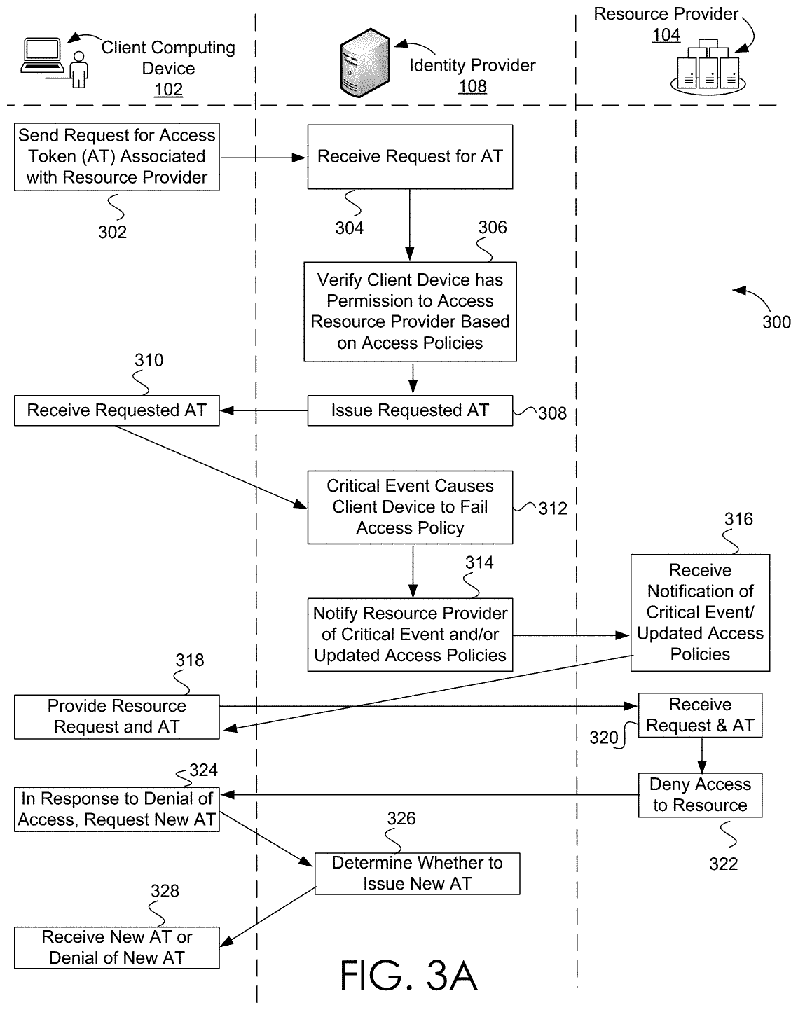

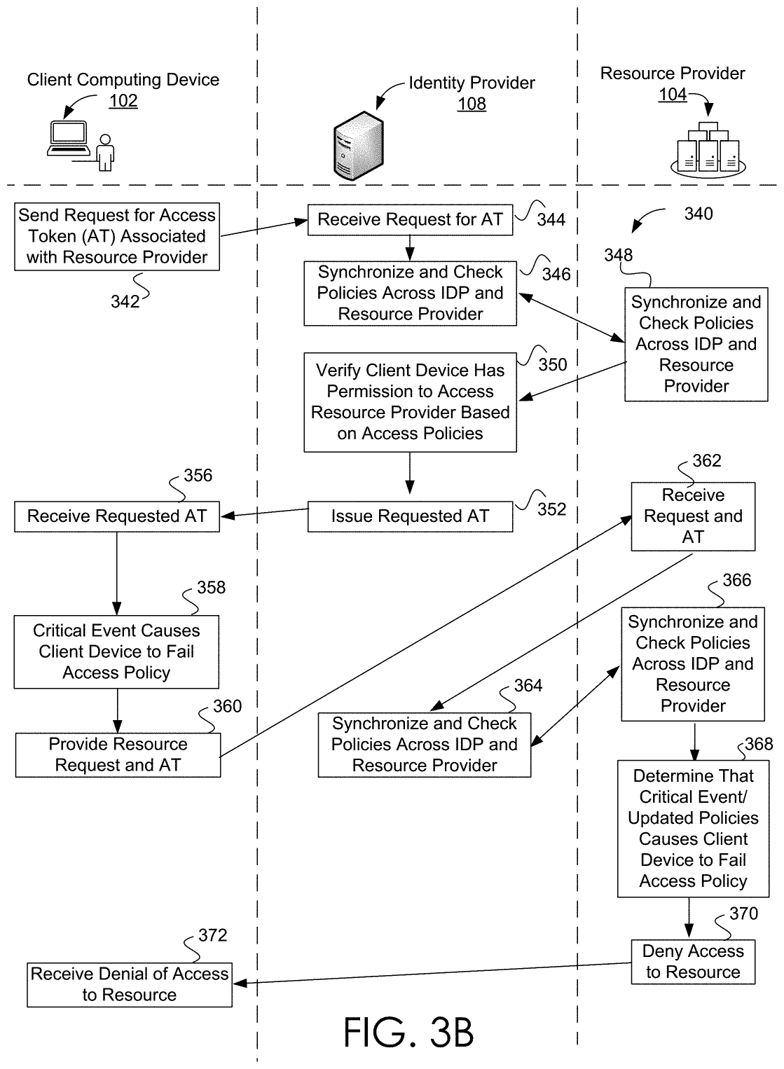

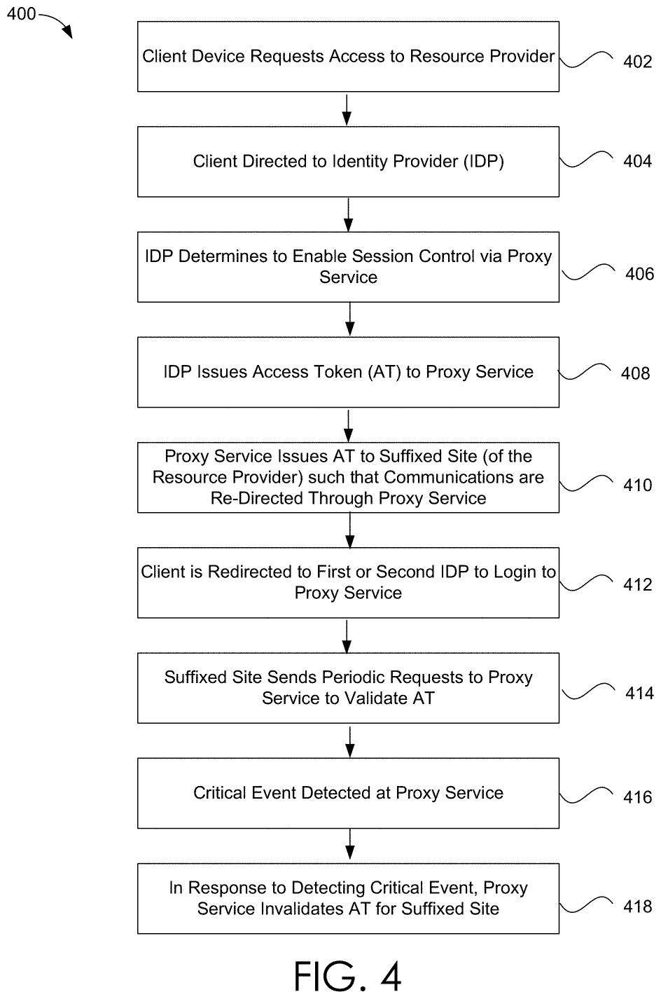

With reference to FIGS. 3A-4, flow diagrams are provided illustrating methods for enabling continuous access evaluation (CAE) for communication sessions over a communication network. The methods may be performed using any of the embodiments described herein. In embodiments, one or more computer storage media having computer-executable instructions embodied thereon that, when executed, can cause the one or more processors to perform the methods in the storage system.

Turning to FIG. 3A, FIG. 3A illustrates a flow diagram of a method 300 for enabling a continuous access evaluation (CAE) communication session between a client and a resource provider. Generally, the flow diagram of FIG. 3A can be implemented using the architecture described above at least in conjunction with FIGS. 1-2C. Various portions of method 300 may be performed via client computing device (e.g., client computing device 102), an identity provider service (IDP) (e.g., IDP 108), and a resource provider (e.g., resource provider 104). The blocks of method 300 are arranged in vertical columns underneath the client computing device 102, the IDP 108, and the resource provider 104 to indicate which of the parties is performing the various actions.

Initially, method 300 begins at block 302, where the client computing device 102 sends a request for an access token associated with the resource provider 104 to the IDP 108. At block 302, the client computing device 102 may provide credentials associated with a user of the client computing device 102. The credentials may include the user's credentials for the resource provider 104. At block 304, the IDP 108 may receive the AT request and the user credentials. At block 306, the IDP 108 may verify that the client device 102 and/or the user has permission to access the resource provider 104. Determining that the client device 102 and/or the user has permission to access the resource provider 104 may be based on access policies for the user, the client computing device 102, and/or the resource provider. The authentication process at block 306 may include comparing various conditions of the environment of the client device 102 and/or user, as well as their credentials. At block 308, the IDP 108 provides the client device 102 with a valid AT. At block 310, the client device 102 receives the valid AT.

During method 300, the IDP may monitor for critical event triggers, as discussed throughout. For example, a backend of the IDP 108 may monitor and detect critical events. At block 312, the IDP 108 detects a critical event that causes the client device 102 to fail an access policy that the client device previously satisfied. For instance, the critical event detected at block 312 may include an administrator of the IDP 108 and/or the resource provider 104 revoking and/or cancelling the account of the user. The resource provider may subscribe to a service for receiving notifications of detected critical events from the IDP 108. At block 314, the IDP 108 may send a notification (or an indication) of the critical event and/or the updated access policies to the resource provider. At block 316, the resource provider 104 may receive the notification of the critical event and/or the updated access policies, for which the client device 102 and/or user now fails.

At block 318, the client device 102 may send a request to access a resource of the resource provider 104. The request may be sent to the resource provider 104. The request may include the valid AT. Note that this request may be sent prior to the AT's expiration, but after the resource provider 104 has received the notification of the critical event at block 316. At block 320, the resource provider 104 may receive the request, along with the AT. At block 322, the resource provider 104 may deny access to the client device 102 based on the notification of the critical event at block 316. Even though the resource provider 104 was presented with a valid (e.g., unexpired) AT, the resource provider 104 may deny the request due to being notified that the user's account has been revoked. At block 322, the resource provider may send a notification of the denial of the request to the client computing device 102.

At block 324, the client device 102 may receive the notification of the denial of access. Also at block 324, and in response to receiving the notification of the denial of access, client device 102 may transmit a request for a new (or refreshed) AT to the IDP 108. At block 326, the IDP 108 may receive the request for the new/refreshed AT. Also at block 326, the IDP 108 may determine whether to issue a new/refreshed AT or deny the request based on the nature of the critical event detected at block 312 and/or the updated access policies. At block 326, the IDP 108 may either send the new AT or an indication that the request for the new AT is denied to the client device 102. At block 328, the client device may receive the new AT or the indication that the request is denied.

Turning to FIG. 3B, FIG. 3B illustrates a flow diagram of another method 340 for enabling a continuous access evaluation (CAE) communication session between a client and a resource provider. Generally, the flow diagram of FIG. 3B can be implemented using the architecture described above at least in conjunction with FIGS. 1-2C. Various portions of method 340 may be performed via client computing device (e.g., client computing device 102), an identity provider service (IDP) (e.g., IDP 108), and a resource provider (e.g., resource provider 104). The blocks of method 340 are arranged in vertical columns underneath the client computing device 102, the IDP 108, and the resource provider 104 to indicate which of the parties is performing the various actions.

Initially, method 340 begins at block 342, where the client computing device 102 sends a request for an access token associated with the resource provider 104 to the IDP 108. At block 342, the client computing device 102 may provide credentials associated with a user of the client computing device 102. The credentials may include the user's credentials for the resource provider 104. At block 344, the IDP 108 may receive the AT request and the user credentials. At blocks 346 and 348, the IDP 108 and the resource provider 104 may synchronize access policies across the platforms. At block 350, the IDP 108 may verify that the client device 102 and/or the user has permission to access the resource provider 104 based on the synchronized access policies. At block 352, the IDP may issue the request AT to the client device 102. At block 356 the client device 102 may receive the AT.

At block 358, a critical event may cause the client device to fail one or more access policies. For example, as discussed in conjunction with FIG. 2B, the client device 102 may move from a region of allowable IP addresses to a region of non-allowable IP addresses. At block 360, the client device 102 may transmit a request for a resource located at resource provider 104. The request may include the valid AT. At block 362, the resource provider 104 may receive the request and the valid AT. At blocks 364 and 366, the IDP 108 and the resource provider 104 may synchronize access policies across the platforms. The synchronization of the access policies may include an indication of the critical event 358. That is, due to the synchronization of the access policies, the resource provider 104 may become aware of the critical event and/or the consequences of the critical event to the client device's 102 and/or the user's permissions to access the resource provider 104.

At block 368, the resource provider 104 may determine that the updated access policies cause the client device 102 and/or the user to fail an access policy that they satisfied prior to the critical event of block 358. At block 370, the resource provider may send a transmission to the client device that the request for access is denied. At block 372, the client device may receive the notification indicating the denial of access.

Turning to FIG. 4, FIG. 4 illustrates a flow diagram of another method 400 for enabling a continuous access evaluation (CAE) communication session that includes a proxy service. Generally, the flow diagram of FIG. 4 can be implemented using the architecture described above at least in conjunction with FIGS. 1-2C. Various portions of method 400 may be performed by any of client computing device (e.g., client computing device 102), a first identity provider service (IDP) (e.g., first IDP 108), a second IDP (e.g., second IDP 128), a resource provider (e.g., resource provider 104), and a proxy service (e.g., proxy service 106).

Initially, method 400 begins at block 402, where a client computing device sends a request to access a resource provider. The request may also include a request for an access token (AT). At block 404, the client may be directed towards an IDP. The IDP may be a first IDP (e.g., first IDP 108). At block 406, the first IDP may determine to consult a proxy service. The IDP (or the proxy service) may determine to enable a session control on the CAE communication session between the client device and the resource provider. At block 408, the first IDP may issue an AT to the proxy service.

In some embodiments, the proxy service may be a suffix proxy. Accordingly, communications between the client and the resource provide may be routed through the proxy service via a suffixed URL that corresponds to a suffixed site. At block 410, the proxy service (or the first IDP) may issue the AT to a suffixed site (via a suffixed URL). The suffixed URL acts to redirect communications through the proxy service. At block 412 (or block 410, the client ay be re-directed to the first IDP or the second IDP (e.g., second IDP 128) so that the user may provide their login credentials to the proxy service. At block 414, the suffixed site (e.g., the resource provider's site suffixed by an URL that indicates the proxy service) may send periodic requests to the proxy service to validate the AT. Because the AT is valid, the proxy site may validate the AT. At block 416, the proxy service may detect a critical event that has consequences on the access permissions of the client. At block 418, in response to the critical event, for the next validation request from the suffixed site, the proxy service may invalidate the AT. Invalidating the AT may terminate the communication session between the client and the resource provider.

### Other Embodiments

The embodiments described herein may be directed towards one or more of methods, system, and/or non-transitory computer readable storage media. One exemplary, but non-limiting embodiment comprises a method that may include receiving, at a first computing device and from a second computing device, a request for an access token (AT). The AT may correspond to a third computing device. The method may further include determining that the second computing device is authorized to access the third computing device. Such a determination may be based on at least the second computing device satisfying an access policy. In response to determining that the second computing device is authorized to access the third computing device, the first computing device may provide the requested AT to the second computing device. An event may be detected that renders the second computing device as now not satisfying the access policy. The detected event may be a critical event. In response to detecting the event, the first computing device may provide, to the third computing device, an indication that the second computing device does not now satisfy the access policy.

In various embodiments, the event may include at least one of a deletion of a user account, a disabling of the user account, a change in a user password, a reset of the user password, an enablement of a multi-factor authentication mechanism, a revocation of the AT, a detection of a risk associated with the second computing device, a detection of a risk associated with the third computing device, or a change of an internet-protocol (IP) address associated with the second computing device.

In any combination of the above embodiments, the first computing device may be associated with an identity provider (IDP). The second computing device may be a client computing device and the third computing device may be associated with a resource provider. When the event is detected, the AT may be valid and/or unexpired. The third computing device may subscribe to a notification service of the first computing device. Providing the indication that the second computing devices does not now satisfy the access policy may be based on the third computing device subscribing to the notification service of the first computing device.

In any combination of the above embodiments, a permission for the second computing device to access the third computing device when the second computing device does satisfy the access policy may be different from a permission for the second computing device to access the third computing device when the second computing device does not satisfy the access policy. The event may include a change to the access policy.

Other embodiments are directed to a first computing system. The first computing system may comprise one or more hardware processors and one or more computer-readable media having executable instructions embodied thereon. When the executable instructions are executed by the one or more processors, the one or more hardware processors may execute actions, operations, or steps that may include or comprise receiving, from a second computing system, a request for an access token (AT) that corresponds to a third computing system. The actions may further include determining that the second computing system is authorized to access the third computing system. Such a determination may be based on at least the second computing system satisfying an access policy. In response to determining that the second computing system is authorized to access the third computing system, the first computing system may provide the requested AT to the second computing system. The first computing system may detect an update to the access policy. In response to detecting the update to the access policy, the first computing system may provide to the third computing system an indication of the update to the access policy.

In various embodiments, the update to the access policy may include at least one of: a deletion of a user account, a disabling of the user account, a change in a user password, a reset of the user password, an enablement of a multi-factor authentication mechanism, a revocation of the AT, a detection of a risk associated with the second computing device, a detection of a risk associated with the third computing device, or a change of an internet-protocol (IP) address associated with the second computing device.

In any combination of the above embodiments, the first computing system may be associated with an identity provider (IDP). The second computing system may be a client computing device, and the third computing system may be associated with a resource provider. When the event is detected, the AT may be valid and/or unexpired. The third computing system may subscribe to a notification service of the first computing system. Providing the indication of the update to the access policy may be based on the third computing system subscribing to the notification service of the first computing system.

In any combination of the above embodiments, a permission for the second computing device to access the third computing device when the second computing device does satisfy the access policy is different from a permission for the second computing device to access the third computing device when the second computing device does not satisfy the access policy.

Still other embodiments are directed to a non-transitory computer-readable storage media. The media may store computer-useable instructions that, when used by one or more computing devices, cause the one or more computing devices to perform actions, operations, and/or steps. The actions may comprise receiving, at the first computing device, an access token (AT) associated with a communication session between a second computing device and a third computing device. The first computing device may be employed to monitor communications between the second computing device and the third computing device. Based on monitoring the communications, the first computing device may be employed to detect an event. The event may result in a change of an access permission of the second computing device to the third computing device. In response to detecting the event, the first computing device may invalidate the AT.

In various embodiments, the event may include at least one of a deletion of a user account, a disabling of the user account, a change in a user password, a reset of the user password, an enablement of a multi-factor authentication mechanism, a revocation of the AT, a detection of a risk associated with the second computing device, a detection of a risk associated with the third computing device, or a change of an internet-protocol (IP) address associated with the second computing device.

In any combination of the above embodiments, the first computing device may be associated with a proxy service. The second computing device may be a client computing device and the third computing device may be associated with a resource provider. When the event is detected, the AT may be valid and/or unexpired. The third computing device may subscribe to a notification service of the first computing device. Providing the indication that the second computing device does not now satisfy the access policy may be based on the third computing device subscribing to the notification service of the first computing device.

### Generalized Computing Device

With reference to FIG. 5, computing device 500 includes a bus 510 that directly or indirectly couples the following devices: memory 512, one or more processors 514, one or more presentation components 516, one or more input/output (I/O) ports 518, one or more I/O components 520, and an illustrative power supply 522. Bus 510 represents what may be one or more buses (such as an address bus, data bus, or combination thereof). Although the various blocks of FIG. 5 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 5 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 5 and with reference to “computing device.”

Computing device 500 typically includes a variety of computer-readable media. Computer-readable media can be any available media that can be accessed by computing device 500 and includes both volatile and nonvolatile media, removable and non-removable media. By way of example and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 500. Computer storage media does not comprise signals per se. Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 512 includes computer storage media in the form of volatile and/or nonvolatile memory. The memory may be removable, non-removable, or a combination thereof. Exemplary hardware devices include solid-state memory, hard drives, optical-disc drives, etc. Computing device 500 includes one or more processors 514 that read data from various entities such as memory 512 or I/O components 520. Presentation component(s) 516 presents data indications to a user or other device. In some implementations, presentation component 220 of system 200 may be embodied as a presentation component 516. Other examples of presentation components may include a display device, speaker, printing component, vibrating component, and the like.

The I/O ports 518 allow computing device 500 to be logically coupled to other devices, including I/O components 520, some of which may be built in. Illustrative components include a microphone, joystick, game pad, satellite dish, scanner, printer, wireless device, etc. The I/O components 520 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition (both on screen and adjacent to the screen), air gestures, head and eye tracking, and touch recognition associated with displays on the computing device 500. The computing device 500 may be equipped with depth cameras, such as stereoscopic camera systems, infrared camera systems, RGB camera systems, and combinations of these for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

Some embodiments of computing device 500 may include one or more radio(s) 524 (or similar wireless communication components). The radio 524 transmits and receives radio or wireless communications. The computing device 500 may be a wireless terminal adapted to receive communications and media over various wireless networks. Computing device 500 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

With reference to the technical solution environment described herein, embodiments described herein support the technical solution described herein. The components of the technical solution environment can be integrated components that include a hardware architecture and a software framework that support constraint computing and/or constraint querying functionality within a technical solution system. The hardware architecture refers to physical components and interrelationships thereof, and the software framework refers to software providing functionality that can be implemented with hardware embodied on a device.

The end-to-end software-based system can operate within the system components to operate computer hardware to provide system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low-level software written in machine code can provide more complex functionality to higher levels of software. As used herein, computer-executable instructions include any software, including low-level software written in machine code, higher level software such as application software, and any combination thereof. In this regard, the system components can manage resources and provide services for system functionality. Any other variations and combinations thereof are contemplated with embodiments of the present disclosure.

By way of example, the technical solution system can include an Application Programming Interface (API) library that includes specifications for routines, data structures, object classes, and variables that may support the interaction between the hardware architecture of the device and the software framework of the technical solution system. These APIs include configuration specifications for the technical solution system such that the different components therein can communicate with each other in the technical solution system, as described herein.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present disclosure are described with reference to a distributed computing environment; however, the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present disclosure may generally refer to the technical solution environment and the schematics described herein, it is understood that the techniques described may be extended to other implementation contexts.

Embodiments of the present disclosure have been described in relation to particular embodiments which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects hereinabove set forth together with other advantages that are obvious and which are inherent to the structure.

It will be understood that certain features and sub-combinations are of utility and may be employed without reference to other features or sub-combinations. This is contemplated by and is within the scope of the claims.

What is claimed is:

1. A method implemented at a first computing device, the method comprising:
receiving, from a second computing device, a request for an access token (AT) that corresponds to a third computing device;
determining, based on at least the second computing device satisfying an access policy, that the second computing device is authorized to access the third computing device;
in response to determining that the second computing device is authorized to access the third computing device, providing the requested AT to the second computing device;
detecting an event that renders the second computing device as now not satisfying the access policy; and
in response to detecting the event, providing, to the third computing device, an indication that the second computing device does not now satisfy the access policy.

2. The method of claim 1, wherein the event includes at least one of:
a deletion of a user account;
a disabling of the user account;
a change in a user password;
a reset of the user password;
an enablement of a multi-factor authentication mechanism;
a revocation of the AT;
a detection of a risk associated with the second computing device;
a detection of a risk associated with the third computing device; or
a change of an internet-protocol (IP) address associated with the second computing device.

3. The method of claim 1, wherein the first computing device is associated with an identity provider (IDP), the second computing device is a client computing device, and the third computing device is associated with a resource provider.

4. The method of claim 1, wherein when the event is detected, the AT is valid and unexpired.

5. The method of claim 1, wherein the third computing device subscribes to a notification service of the first computing device and the providing of the indication that the second computing device does not now satisfy the access policy is based on the third computing device subscribing to the notification service of the first computing device.

6. The method of claim 1, wherein a permission for the second computing device to access the third computing device when the second computing device does satisfy the access policy is different from a permission for the second computing device to access the third computing device when the second computing device does not satisfy the access policy.

7. The method of claim 1, wherein the event includes a change to the access policy.

8. A first computing system comprising:
one or more hardware processors; and
one or more computer-readable media having executable instructions embodied thereon, which, when executed by the one or more processors, cause the one or more hardware processors to execute actions comprising:
receiving, from a second computing system, a request for an access token (AT) that corresponds to a third computing system;
determining that the second computing system is authorized to access the third computing system based on at least the second computing system satisfying an access policy;
in response to determining that the second computing system is authorized to access the third computing system, providing the requested AT to the second computing system;
detecting an update to the access policy; and
in response to detecting the update to the access policy, providing, to the third computing system, an indication of the update to the access policy.

9. The first computing system of claim 8, wherein the update to the access policy includes at least one of:
a deletion of a user account;
a disabling of the user account;
a change in a user password;
a reset of the user password;
an enablement of a multi-factor authentication mechanism;
a revocation of the AT;
a detection of a risk associated with the second computing device;
a detection of a risk associated with the third computing device; or
a change of an internet-protocol (IP) address associated with the second computing device.

10. The first computing system of claim 8, wherein the first computing system is associated with an identity provider (IDP), the second computing system is a client computing device, and the third computing system is associated with a resource provider.

11. The first computing system of claim 8, wherein when the update to the access policy is detected, the AT is valid and unexpired.

12. The first computing system of claim 8, wherein the third computing device subscribes to a notification service of the first computing device and the providing of the indication of the update to the access policy is based on the third computing device subscribing to the notification service of the first computing device.

13. The first computing system of claim 8, wherein a permission for the second computing device to access the third computing device when the second computing device does satisfy the access policy is different from a permission for the second computing device to access the third computing device when the second computing device does not satisfy the access policy.

14. One or more computer storage media storing computer-useable instructions that, when used by one or more computing devices, cause the one or more computing devices to perform actions comprising:
receiving, at first a computing device, an access token (AT) associated with a communication session between a second computing device and a third computing device;
employing the first computing device to monitor communications between the second computing device and the third computing device;
based on monitoring the communications, detecting an event that results in a change of an access permission of the second computing device to the third computing device; and
in response to detecting the event, invalidating the AT.

15. The media of claim 14, wherein the event includes at least one of:
a deletion of a user account;
a disabling of the user account;
a change in a user password;
a reset of the user password;
an enablement of a multi-factor authentication mechanism;
a revocation of the AT;
a detection of a risk associated with the second computing device;
a detection of a risk associated with the third computing device; or
a change of an internet-protocol (IP) address associated with the second computing device.

16. The media of claim 14, wherein the first computing device is associated with a proxy service, the second computing device is a client computing device, and the third computing device is associated with a resource provider.

17. The media of claim 14, wherein when the event is detected, the AT is valid and unexpired.

18. The media of claim 14, wherein the third computing device subscribes to a notification service of the first computing device and the first computing device provides a notification of the detection of the event to the third computing device.

19. The media of claim 14, wherein a permission for the second computing device to access the third computing device when the AT is valid is different from a permission for the second computing device to access the third computing device when the AT is invalidated.

20. The media of claim 14, wherein the event includes a change to the access policy.
